(19) United States
(12) Patent Application Publication
(10) Pub. No.: US 2014/0160273 A1
(43) Pub. Date: Jun. 12, 2014

(54) METHOD FOR CONTROLLING A TOOL

(71) Applicant: ACSYS Lasertechnik GmbH, Mittweida (DE)

(72) Inventors: Mirko Jedynak, Mittweida (DE); Christian Kreisel, Mittweida (DE); Uwe Heinritz, Mittweida (DE); Rene Liebers, Mittweida (DE)

(73) Assignee: ACSYS Lasertechnik GmbH, Mittweida (DE)

(21) Appl. No.: 13/936,194

(22) Filed: Jul. 7, 2013

(30) Foreign Application Priority Data
Jul. 9, 2012 (DE) DE102012106156.4

(51) Int. Cl. G06K 9/32; H04N 7/18

(52) U.S. Cl. CPC G06K 9/3208; H04N 7/18
USPC 348/95

(57) ABSTRACT

A method for controlling a tool, including the steps: providing a reference matrix including reference points and a centering matrix including centering points in a material processing plane; imaging the material processing plane through a camera as a camera image in a size of a camera image field; de-skewing the camera image of the material processing plane by aligning with the reference matrix; scaling a pixel size of the camera image through aligning with the reference matrix; centering the camera image through aligning with the centering points; projecting a processing contour onto the de-skewed and scaled camera image of a workpiece; and aligning the processing contour on the camera image of the work piece and starting the processing, wherein the processing of the work piece is performed though the tool along the processing contour.

### RELATED APPLICATIONS

This patent application claims priority from and incorporates by reference German patent application DE 10 2012 106 156.4 filed on Jul. 9, 2013.

### FIELD OF THE INVENTION

The invention relates to a method for controlling a position of a tool, wherein CAD data is projected as operating contours, in particular cutting geometries, onto a live camera image of a work piece to be processed.

The method can be used in the fields of sheet metal processing, machining profiles and tubes, in proto type construction and in laser job production.

### BACKGROUND OF THE INVENTION

A preferred application of the invention relates to materials processing through laser cutting which is described in the art in many aspects.

A laser cutting device is known from for example from DE 20 2007 015 908 U1, wherein the laser cutting device collects the used protective gas, cleans it in a filter arrangement and resupplies it to the laser cutting process.

A laser cutting method is known from DE 693 00 568 T2, wherein the laser cutting method is configured to cut plural stacked work pieces, in particular pieces of sheet metal jointly in one method step.

DE 197 16 616 C2 eventually describes a laser cutting method which determines a distance between a laser operating head and a work piece through an electrical resistance between the two components. Also in other documents mostly the technical aspects of various versions of laser cutting are configured, like for example beam routing, tool positioning and using various material variations.

Processing and in particular laser cutting sheet metal, tubes and profiles is typically performed without using positioning systems. The work pieces that are to be processed are typically inserted into a machine with known dimensions and start positions, or they are aligned at fixated, defined stops or aligned with special devices. However, producing such auxiliary devices is rather time consuming and expensive for low volume production.

When cutouts have to be subsequently applied to prefabricated stamped components or additional contours have to be cut at pre stamped work pieces the work pieces are typically aligned rather imprecisely through target lasers in a visible wave length.

As an alternative thereto direct camera monitoring through the cutting gas nozzle is known in the art. Thus, it is very problematic that the cutting gas nozzle restricts the camera image to a large extent due to its diameter of 1.5 mm at the most.

In the field of sheet metal processing small batch sizes down to individual components are often produced besides large numbers. The standard formats of the sheet metal plates from which the work pieces are cut therefore are typically too large to fully utilize these sheet metal plates in one method step. The left over sheet metal plates therefore can only be utilized to their full extent with additional complexity or cannot be used at all for cutting out additional work pieces. A use of positioning systems is desirable for optimum utilization of the materials to be processed.

Conventional nesting software in which identical or different geometries are nested for optimum material utilization cannot be used for this purpose or can only be used with limitations, because the nesting software does not consider when particular geometries are cut out from the work piece.

### BRIEF SUMMARY OF THE INVENTION

Thus, it is an object of the invention to simplify and accelerate positioning of work pieces to be processed. Furthermore, material utilization shall be improved and time savings shall be achieved during machine set up which leads to cost reductions.

The object is achieved through A method for controlling a tool, including the steps: providing a reference matrix including reference points and a centering matrix including centering points in a material processing plane; imaging the material processing plane through a camera as a camera image in a size of a camera image field; de-skewing the camera image of the material processing plane by aligning with the reference matrix; scaling a pixel size of the camera image through aligning with the reference matrix; centering the camera image through aligning with the centering points; projecting a processing contour onto a de-skewed and scaled camera image of a workpiece; and aligning the processing contour on the de-skewed and scaled camera image of the work piece and starting the processing of the work piece through the tool along the processing contour. Improvements are provided in the dependent patent claims.

According to the invention the object is achieved in particular through a method for controlling a tool for which a reference matrix made from reference points and a centering matrix made from centering points is provided in a material processing plane. The image of the material processing plane is generated through a camera as a camera image with the size of the camera image field. The method is implemented in that the system de-skews the camera image once upon start up through alignment with the reference matrix, in that the method scales the pixel size of the camera image through alignment with the reference matrix, in that the method centers the camera image through alignment with the centering points on a centering plate and in that the method projects a processing contour onto the de-skewed scaled and centered image of the work piece. During the last phase the processing contour can be aligned relative to the image of the work piece or the image of the work piece can be aligned at will relative to the illustrated processing contour. Eventually the processing is started wherein the processing of the work piece is performed by the tool along the processing contour.

A reference matrix is generally defined as a number of points in space or in a plane, based on which the systems are aligned. The reference matrix is configured for the method described herein as a uniform pattern of reference points configured as crosses which are arranged in precisely defined distances in lines and columns that are arranged perpendicular to one another. Also other geometries, for example circles or points are feasible.

The pattern has to satisfy the requirement that the control program can draw conclusions with respect to the type of skewing to which the image is subjected from the imaging of the reference matrix by the camera. The imaging error is generated on the one hand side through the skewing of the lens, in particular in the corner portions and on the other hand side through a misalignment of the camera which is not positioned absolutely vertical above the processing plane. This way a camera can also be used that is aligned at a slant angle with respect to depth sharpness, wherein the image field of the camera is for example arranged directly under the laser processing head. Through information regarding the degree of skewing the skewing can be compensated computationally for all subsequent images.

In analogy thereto to the centering matrix is defined as a marking which is arranged on a stable carrier in exactly defined distances relative to two sides that are arranged orthogonal to one another. When these sides firmly contact a stop of the material processing table also the position of the centering matrix relative to the laser is exactly defined. In the simplest case the centering matrix only includes a single centering point. According to an advantageous embodiment of the invention the centering matrix is configured as an arrangement of three centering points.

The centering points are arranged to establish a relationship of the laser processing head with the camera, this means in order to measure a distance of a camera center point to a processing head center point and to measure a rotation of the x-y-axes of the camera relative to the x-y-processing axes of the machine. Thus, the center point of the camera image can be centered on the laser image through imaging these points.

While the lens—camera—correction typically only has to be performed once it can become necessary to perform the centering procedure several times for example when the processing head or the camera contact a work piece, wherein a slight contacting can already be enough depending on the resolution or precision that is desired.

The reference matrix and the centering matrix are typically arranged on a separate plate because flatness is important for precision of the alignment. Possible deviations from the flatness of the plate are new possible error sources for the system.

The term material processing plane designates the surface above the material processing table in which the focus of the laser beam impacts the work piece. For workpieces with steps in their surface profiles this plane can also include plural surfaces above the level of the material processing table or it can even include planes that are inclined relative to the material processing table. Movability of the laser processing head orthogonal to the material processing table is a requirement for processing work pieces of this type. The term laser processing head is used to differentiate over a laser head which typically designates a mere laser source. In this case, however, a processing head that is configured with focusing optics is being discussed.

The processing contour designates on the one hand side an arrangement of points or lines which is stored in the CAD data, on the other hand side the processing contour is imparted onto the work piece through the path of the laser during the laser cutting process. In case of laser engraving the processing contour can also designate the arrangement of the characters to be engraved.

It is an advantageous embodiment of the invention that the reference matrix and the centering points are configured on a reference plate in the material processing plane. Optionally, the centering points can also be arranged on a separate centering plate.

For practical applications it is particularly advantageous that the processing contour is imported from CAD data or generated at the processing machine and that plural processing contours can be projected onto the un-skewed and scaled image of the work piece. In this stage there is an option to perform additional position corrections or a movement of the processing start point.

The invention is advantageously implemented so that a size of the image cut out and thus precision of positioning is adaptable to the application through selectable camera—lens combinations and a continuous digital zoom function.

According to an advantageous embodiment of a device for performing the method the tool is configured as a laser processing head.

According to another optimization measure the camera is attached directly at the laser processing head.

According to one embodiment of the invention the size of the camera image field is put together from one or plural images to form an overall image. Through configuring the overall image from plural individual images it is facilitated to achieve the high resolution of the individual camera image for the overall image.

An advantageous alternative for configuring the device and the method that can be performed with the device is provided in that the camera is positioned in the machine operating space independently from the laser processing head, wherein the camera image field images a large portion of the laser operating space. Thus, camera image capture can be simplified for images with sufficient resolution and precision depending on the application.

It is a particular advantage of the solution according to the invention that it is useable for a plurality of material processing methods like for example engraving, milling, scratching, sawing or flame cutting since it functions independently from the type of material processing.

The invention is based on the concept that a camera based coordinate system is added to the coordinate system of the material processing table which is connected with the control program of the laser processing head, wherein the camera based coordinate system is de-skewed, scaled and centered through the described method. Through the option of a transformation between the two coordinate systems thus obtained, the geometry to be cut can be projected directly onto the image of the work piece and the positioning process can be monitored in real time via camera.

The describe method provides improvements over solutions that are known in the art in that the system significantly reduces set up complexity for machines and tools and facilitates exact positioning also for small work pieces. Thus, an option of simple positioning of diverse cut outs is also provided for small batches and prototypes. Eventually also left over plates and be utilized in an optimum manner and can be processed in a time saving manner.

### BRIEF DESCRIPTION OF THE DRAWINGS

Additional details, features and advantages of embodiments of the invention can be derived from the subsequent description of embodiments with reference to associated drawing figures, wherein:

FIG. 1 illustrates a correction of imaging errors;

FIG. 2 illustrates a centering of the center point of the camera;

FIG. 3 illustrates projecting and positioning a cutting contour on a work piece;

FIG. 4 illustrates embodiment 1: camera positioned at laser processing head;

FIG. 5 illustrates embodiment 2: camera position at laser processing head with overall image assembled from individual images; and

FIG. 6 illustrates embodiment 3: camera position in machine operating space.

### DETAILED DESCRIPTION OF THE INVENTION

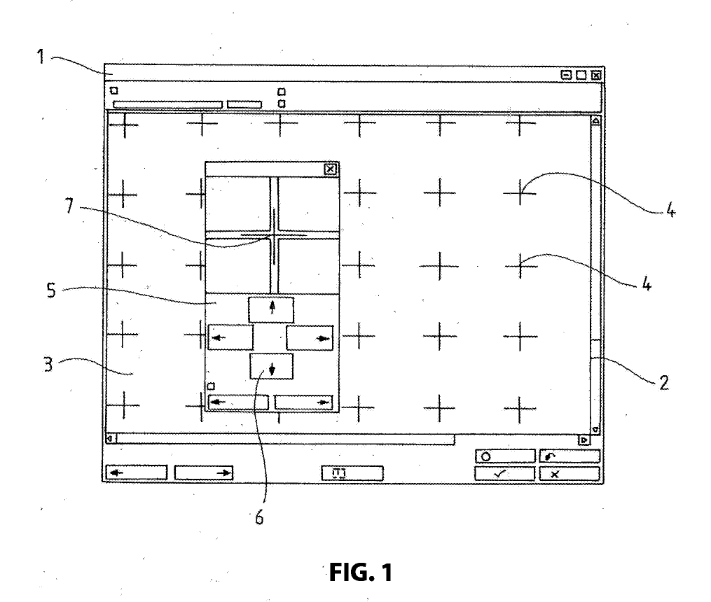

FIG. 1 illustrates a screen output of a control program 1 during correction of camera distortion, wherein a reference matrix 3 configured as evenly offset scaling crosses 4 is reproduced on a reference plate in a control window 2. A centering window 5 with super imposed target cross 7 is preferably positioned through cursor keys exactly on a selected reference point of the reference matrix 3, wherein the reference point is configured as a scaling cross 4. The skewing of the camera image is corrected in particular in the outer portion in that plural scaling crosses 4 of the reference matrix 3 are aligned one after the other with the target cross 7 of the camera image. This correction function corrects the skewing of the camera images for all subsequent images of work pieces.

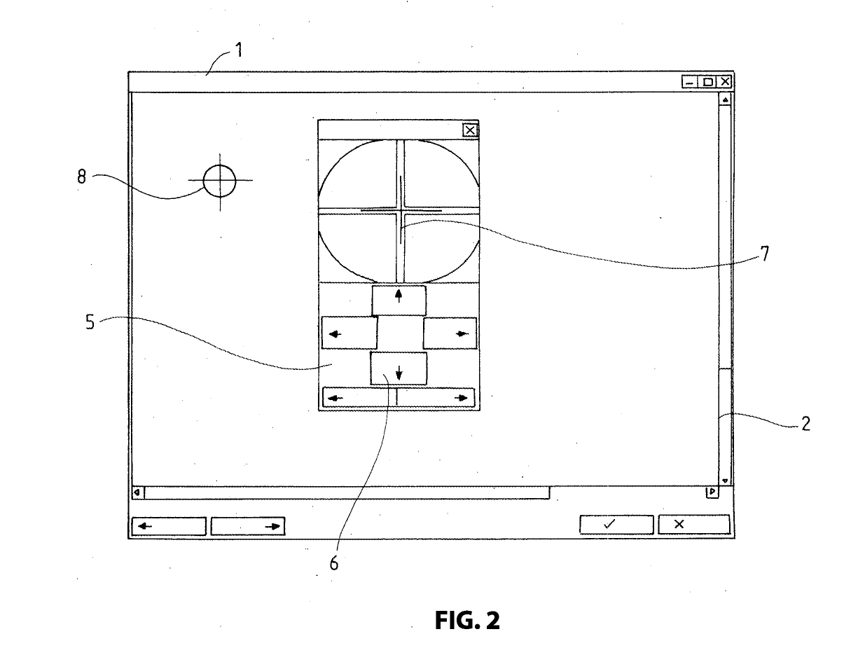

FIG. 2 illustrates the screen output of the control program 1 while centering the center point of the camera image, wherein the centering window 5 is aligned in the control window with the target cross 7 through cursor-keys 6 exactly on one of the reference points of a centering plate configured as centering point 8. After approaching a first centering point 8 a second centering point 8 is approached which is on the left and below the first centering point and eventually a third centering point 8 is approached which is on the right and above the first centering point. This method step aligns a center of the camera image with a center of the laser.

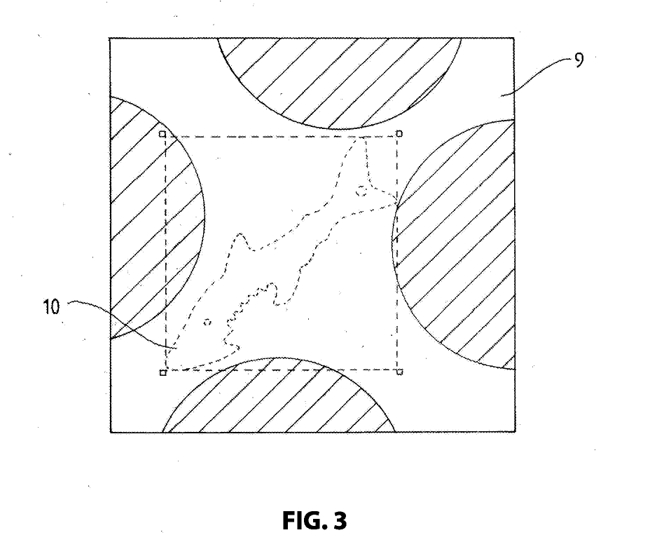

FIG. 3 illustrates the screen output of the control program 1 in which the processing contour which was previously generated or imported is projected on an image of the work piece 9. The continuous digital zoom function facilitates performing additional position corrections or also adding additional processing contours 10. In this view the scaled, centered, and de-skewed camera image is illustrated as a background for the processing contour 10. The processing contour 10, represented in the embodiment as a shark contour can therefore be positioned on the plate exactly between the cutouts in the work piece 9. Movements of the processing contour can therefore be performed without errors since the camera image errors which cannot be optically corrected completely were corrected through software through the preceding method steps.

The subsequent figures illustrate optional embodiments which differ with respect to the camera image fields and resolutions and with respect to the camera positions within the machine.

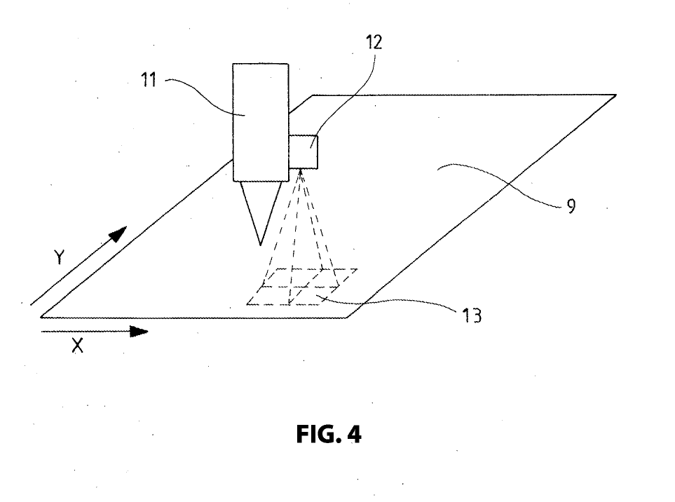

FIG. 4 illustrates an embodiment in which the camera 12 is arranged directly at the tool, the laser processing head 11, and moved together with the laser processing head 11. Thus there is no relative movement between the laser processing head 11 and the camera 12. The camera image has a high level of detail and high resolution due to proximity to the surface of the work piece 9. The size of the camera image field 13 in the embodiment is in a range of at least 15 mm width and 20 mm length up to a maximum of 225 mm width and 300 mm length and is adjustable through the lens arrangement of the camera. Thus different image size and resolution combinations are selectable. The maximum resolution is approximately eight pm per pixel in the illustrated advantageous embodiment. The camera image field 13 is arranged in an x-y-plane in FIG. 4, wherein the work piece 9 configured as a plate is arranged in this plane.

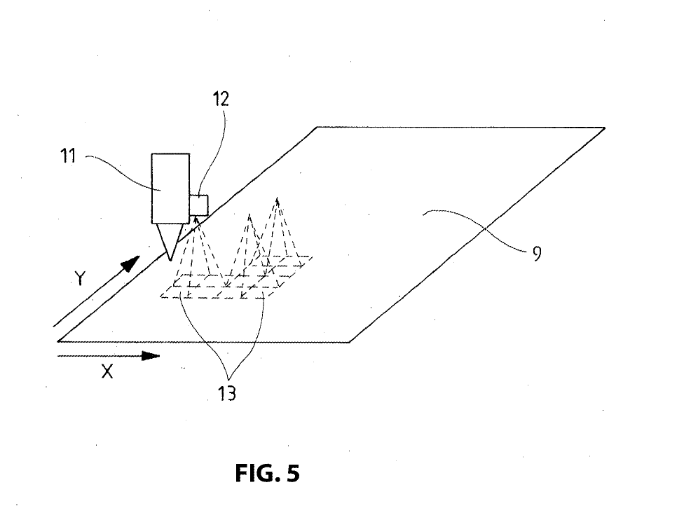

FIG. 5 illustrates an embodiment arranging the camera 12 at the laser processing head 11 analogous to FIG. 4. The size of the total image however, is assembled from a plurality of individual camera image fields 13 which are assembled to form a total image. The maximum achievable resolution of the total image in pm per pixel corresponds to the individual image resolution selected in FIG. 4. The size of the total image is then only limited by the operating space of the machine. With this embodiment also large work pieces 9, in particular large plates can be processed with high resolution, wherein also a plurality of smaller processing contours can be arranged on the entire work piece 9 before processing starts. The processing can then be performed by the laser for the entire work piece in one method step.

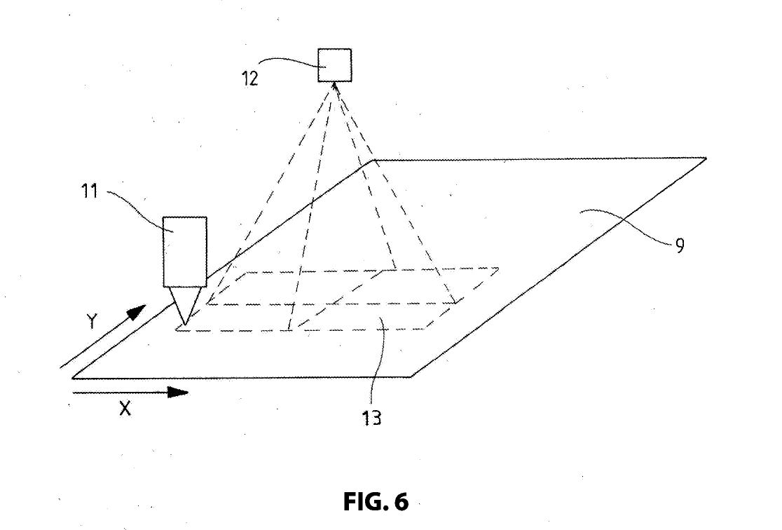

FIG. 6 illustrates a configuration in which the camera 12 is arranged in the machine operating space independently from the laser processing head 11. The camera field image 13 images a large portion of the laser operating space and advantageously has a size of 500 mm—500 mm edge length and a maximum resolution of approximately 175 μm per pixel.

### REFERENCE NUMERALS AND DESIGNATIONS

1 control program
2 control window
3 reference matrix on reference plate
4 scaling cross
5 centering window
6 cursor keys
7 target cross
8 centering point
9 work piece
10 processing contour
11 laser processing head
12 camera
13 camera image field

What is claimed is:

1. A method for controlling a tool, comprising the steps:
providing a reference matrix including reference points and a centering matrix including centering points in a material processing plane;
imaging the material processing plane through a camera as a camera image in a size of a camera image field;
de-skewing the camera image of the material processing plane by aligning with the reference matrix;
scaling a pixel size of the camera image through aligning with the reference matrix;
centering the camera image through aligning with the centering points;
projecting a processing contour onto a de-skewed and scaled camera image of a workpiece; and
aligning the processing contour on the de-skewed and scaled camera image of the work piece and starting the processing of the work piece through the tool along the processing contour.

2. The method according to claim 1, wherein the reference matrix and the centering matrix are configured on a reference plate in the material processing plane.

3. The method according to claim 1, wherein the processing contour is imported from CAD-data or generated at a processing machine.

4. The method according to claim 1, wherein plural processing contours are projected onto the de-skewed and scaled camera image of the work piece.

5. The method according to claim 1, wherein a size of the camera image field and precision of positioning are adapted to an application through selectable camera-lens arrangement combinations.

6. The method according to claim 1, wherein the tool is configured as a laser processing head.

7. The method according to claim 1, wherein the camera is attached at the laser processing head.

8. The method according to claim 1, wherein a size of the camera image field is assembled from plural images to form a total image.

9. The method according to claim 1, wherein the camera is positioned independently from the laser processing head in a machine operating space.

10. The method according to claim 1, wherein processing the workpiece is performed through engraving, milling, scratching, sawing or flame cutting.
